(19) United States
(12) Patent Application Publication
(10) Pub. No.: US 2010/0111332 A1
(43) Pub. Date: May 6, 2010

(54) Microphone set for AV system

(76) Inventor: Wai Chi Ting, Monterey Park, CA (US)

Correspondence Address: DAVID AND RAYMOND PATENT FIRM, 108 N. YNEZ AVE., SUITE 128, MONTEREY PARK, CA, 91754, US

(21) Appl. No.: 12/290,553

(22) Filed: Oct. 31, 2008

(51) Int. Cl. H04R 3/00

(52) U.S. Cl. 381/122

(57) ABSTRACT

The present invention is a microphone set for AV system which comprises a hand-held microphone housing and a AV controller. The AV controller comprises a voice module for receiving a voice signal from a user, a data module for receiving an external AV data from an external storage, an audio/video module adapted for operatively connecting to the AV system for transmitting a video signal and a sound signal thereto, and an audio generator which is arranged for splitting the AV data into the video data and the audio data to be converted into the video signal and an audio signal respectively, and for blending the voice signal with the audio signal to form the sound signal, so as to transmit the video signal and the sound signal to the AV apparatus through the audio/video module.

### BACKGROUND OF THE PRESENT INVENTION

1. Field of Invention

The present invention relates to a microphone set, and more particularly to a microphone set providing both audio and video signals coordinated to play.

2. Description of Related Arts

Karaoke is a very popular activity for entertainment, people can have the music accompaniment played during singing. Some karaoke equipments also provide background video and lyric reminding displayed on TV set simultaneously. To achieve this, generally karaoke equipment has a microphone for collecting user's voice; a medium reader for reading information of music accompaniment, video background, and lyrics; and an output element for playing the user's voice mixed with the music accompaniment, the video background, and the lyric. The medium which stores the information of music accompaniment, video background and lyrics could be tape, CD, VCD, DVD, hard dick, SD card, etc.

There are two trends for the development of karaoke equipment. One is to be more portable, and the other is to be more powerful. The portable karaoke equipments are getting smaller and smaller for people to easily carry and use. Now a whole karaoke equipment can be integrated into the size of a regular microphone. The video and audio information is stored in small mediums such as built-in flash memories, or removable SD cards. The user only needs to connect the karaoke microphone with output equipment such as speakers and TV set.

But there is a big problem for current using portable karaoke equipment. In order to combine every element into a small microphone, the size of those elements is a big concern. Therefore, only storage media with small occupation such as flash memories can be considered. Then the memory capacity of the storage medium is largely limited. As a result, one karaoke microphone can only provide a small number of songs; other wise the user has to scarify the quality of the music and use highly compressed music format, such as MP3. Even though, there are still some disadvantages for such karaoke microphones. It is more difficult to store video data because the data is much larger audio data. It is very inconvenient to upload new data to those built-in media, it is either not allowable, or requires additional circuits, port, connectors, and external equipments. Also, it is difficult to expand the storage capacity. For those removable cards, a slot is needed to hold the card which is space occupying. Then a special card writer, as well as a computer is required. Also, with more memories are installed, more heat will be generated, and the microphone will get heavier and larger.

In the other trend, karaoke equipments are designed to provide more functions, and more choices of songs. This kind of karaoke equipments generally has a central machine which has a control interface, and is connected with one or more high quality microphones. More particularly, the central machine has a media reader which can read CD, VCD, and DVD, or hard disk. This central machine processes the user's voice with the audio video data read from the media, and output the processed signals to the output equipment, generally a speaker set and a TV set 31.

Although this kind of karaoke equipments can provide high quality performance such as DVD format, and large amount of choices of songs, the disadvantages are: these equipments are not portable; the central machine is large and heavy, the wiring of microphone and output devices is complex, and the processor should be more powerful which also means more expensive. Furthermore, if the data media are optical storage disks such as CD and DVD, many disks with particular karaoke formats have to be purchased. During playing, disks have to be switched frequently for different songs. If the data media are hard disks, it is not convenient to upload new data, and complex to expand or replace the original hard disks.

To fulfill the requirement of being portable, flexible, high quality and large capacity simultaneously, a new karaoke equipment is needed.

### SUMMARY OF THE PRESENT INVENTION

The main object of the present invention is to provide a microphone set which can access large memory capacity for storing audio and video information, and provide this information for output equipment.

Another object of the present invention is to provide a microphone set which can input voice signal and output processed audio and video signals.

Another object of the present invention is to provide a microphone set with karaoke functions.

Another object of the present invention is to provide a microphone set with karaoke functions which is portable.

Another object of the present invention is to provide a microphone set with karaoke functions which is easy to install audio and video information.

Another object of the present invention is to provide a microphone set with karaoke functions providing high quality audio and video signals.

Another object of the present invention is to provide a microphone set with karaoke functions which is easy to access different data storages.

Another object of the present invention is to provide a microphone set with karaoke functions which can control the access of the data storage.

Another object of the present invention is to provide a microphone set with karaoke functions which can easily expand the memory capacity.

Another object of the present invention is to provide a microphone set with karaoke functions which is easy to connected with output equipments.

Another object of the present invention is to provide a microphone set with karaoke functions which can output and record the processed audio signals simultaneously.

Another object of the present invention is to provide a microphone set with karaoke functions which is using inexpensive electric elements.

Accordingly, in order to accomplish the above objects, the present invention provides a microphone set for an AV (audio/video) system including an external data storage and an AV display, comprising:

a hand-held microphone housing;

an AV controller, which is received in the microphone housing, comprising a voice module for receiving a voice signal from a user, a data module for receiving an external AV data from the external data storage which contains an audio data and a video data, an audio/video module adapted for operatively connecting to the AV display for transmitting a video signal and a sound signal thereto, and an audio generator operatively linked among the voice module, the data module, and the audio/video module, wherein the audio generator is arranged for splitting the AV data into the video data and the audio data to be converted into the video signal and an audio signal respectively, and for blending the voice signal with the audio signal to form the sound signal, so as to transmit the video signal and the sound signal to the AV display through the audio/video module;

a power terminal which is connected with the AV controller and is detachably connected with an external power source for power supplying;

a data terminal which is connected with the data module and is detachably connected with the external data storage for transmitting AV data; and

an AV terminal which is connected with the audio/video module and is detachably connected with the AV display for transmitting the video signal and the sound signal.

The present invention also provides a method for receiving external AV data and outputting AV signal to an AV system, comprising steps of:

(a) inputting a voice signal through a microphone;

(b) receiving the external AV (audio video) data by a data module from an portable external data storage;

(c) generating an sound signal by mixing the voice signal with the audio data received from the portable external data storage;

(d) converting the video data received from the portable external data storage to video signal; and

(e) outputting the sound signal and the video signal to the AV system.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an embodiment of the present invention.

FIG. 2 is a block diagram of an embodiment of the present invention.

FIG. 3 is a schematic view of a single cable of the present invention.

FIG. 4 is a sectional view of a single cable of the present invention.

FIG. 5 is a flow diagram of a method for receiving external AV data and outputting AV signal to an AV system of the present invention.

### DETAILED DESCRIPTION OF THE PREFERRED EMBODIMENT

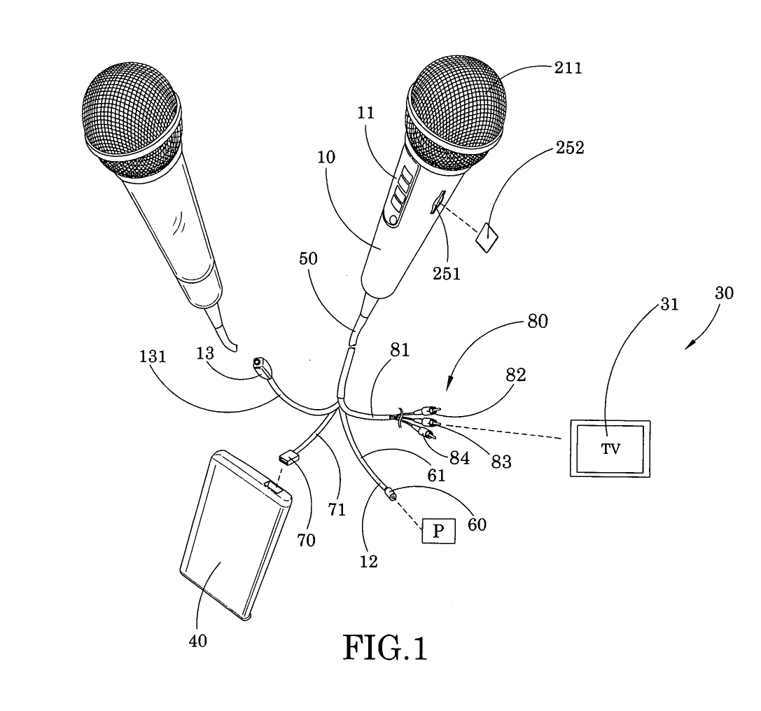

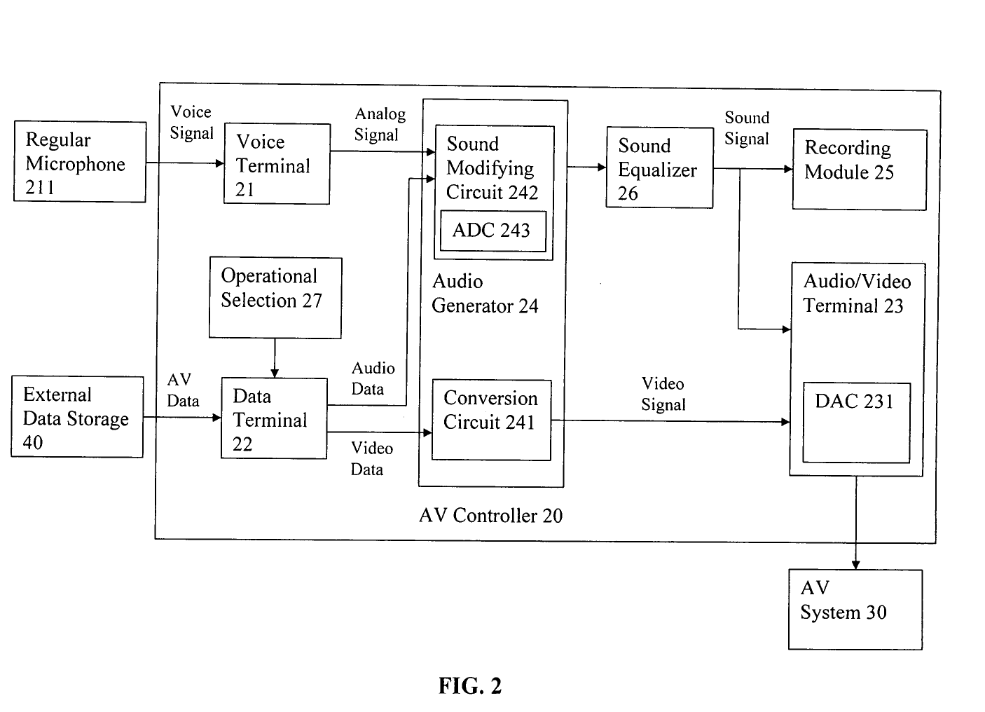

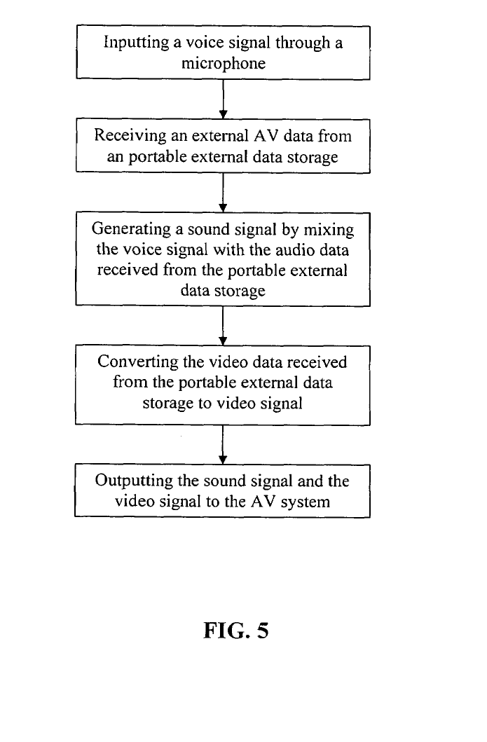

Referring to FIGS. 1 to 5, a preferred embodiment of a microphone set for an AV (audio/video) system of the present invention comprises a hand-held microphone housing 10, and an AV controller 20 which is received in the microphone housing 10. The AV controller 20 comprises a voice module 21, data module 22, an audio/video module 23, and an audio generator 24.

The voice module 21 is adapted to receive voice signals, for example, the singing from a user. The voice module 21 has a regular microphone 211 to collect the analog voice signal.

The data module 22 is adapted to receive an external AV data. Preferably, this AV data comprises audio data such as music accompaniment, and video data such as back ground images. The AV data also comprises other information such as lyrics, song list, original singer's names, control information, etc. The data module 22 separates the video data and the audio data respectively from the AV data for further process.

The audio generator 24 is adapted to generate the audio signal for outputting. The audio generator 24 is linked with the voice module 21 for receiving the voice signal from the voice module 21. The audio generator 24 is also linked with the data module 22 for receiving the video data and the audio data respectively. The audio generator 24 also comprises a conversion circuit 241 to convert the video data into a video signal, and a sound modifying circuit 242 to mix the isolated audio data with the received voice signal to form an analog sound signal. This analog sound signal gives the effect of a singer singing with music accompanied. The audio generator 24 also comprises an ADC (Analog/Digital Converter) 243 to convert the analog sound signal into a digital sound signal.

The audio/video module 23 is communicatively connected with the audio generator 24 to receive the isolated video signal, and the generated sound signal. The audio/video module 23 further comprises a DAC (Digital/Analog Converter) 231 to convert the received video signal and sound signal into analog video signal and analog sound signal. The audio/video module 23 is also operatively connected with an AV system 30 to transfer the received video signal and the sound signal from the audio generator 24. Preferably, the AV system 30 is a TV set 31 having an audio input and a video input. In this manner, the TV set 31 is able to play the analog sound signal for user to listen, and show the video signal for user to watch. It is worth to mention that if the TV set 31 has a digital input, the audio generator 24 can directly output the digital video and sound signal to the TV set 31 without any analog conversion.

A preferred embodiment of a microphone set of the present invention also comprises a power terminal 60, a data terminal 70, and an AV terminal 80. The power terminal 60 comprises a power cable 61 extended from the microphone housing 10 to electrically connect with the AV controller 20 therethrough. The power terminal 60 is also detachably connected with an external power source for power supplying.

The data terminal 70 comprises a data cable 71 extended from the microphone housing 10 to electrically connect with the data module 22 therethrough. The data terminal 70 is also detachably connected with the external data storage 40 for transmitting AV data.

The AV terminal 80 comprises an AV cable 81 extended from the microphone housing 10 to electrically connect with the audio/video module 23. The AV terminal 80 is also detachably connected with the AV system 30 for transmitting the video signal and the sound signal. In the preferred embodiment, the AV cable 81 comprises a video wire 82, a left channel audio wire 83, and a right channel wire 84.

The microphone set of the present invention also comprises a microphone connector 13 for operatively connecting with an auxiliary microphone so as to process a secondary voice signal. The microphone connector 13 also comprises an extension cable 131 extended from the microphone housing 10 to electrically connect with the AV controller 20. Then the two voice signals are combined together with the audio data to form the sound signal through the audio generator 24.

The data cable 71, the AV cable 81, the power cable 61, and the extension cable 131 are arranged together to form a single cable 50 and are enclosed by an isolating layer 51. One end of the single cable 50 is extended from the microphone housing 10. On the other end of the single cable 50, the power terminal 60, the data terminal 70, the AV terminal 80, and the microphone connector 13 are separated for detachably connecting with power source, external data storage 40, AV system 30 and auxiliary microphone respectively.

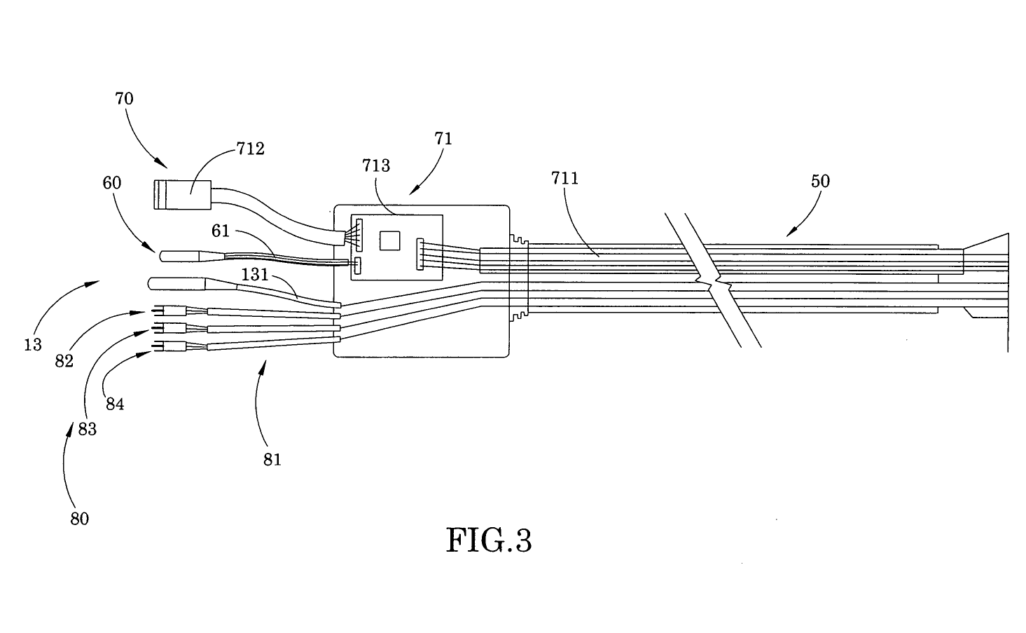

In the preferred embodiment of the present invention, the power cable 12 is the power wires of a USB cable 711. Referring to FIG. 3, a USB cable 711 has two data lines D+ and D−, and two power lines V+ and V−. The power cable 71 is using the two power lines V+ and V− to provide 5V power supply.

It is important to know that the external AV data is stored in a portable external data storage 40. In a preferred embodiment, the external data storage 40 is a portable hard disk drive (HDD), a solid state drive (SSD), or flash-based memory storage which is detachably connected with the microphone set of the present invention. HDD/SSD is portable, having small weight and size. At the same time, it has a huge capacity for storing a large amount of AV data. It is easy to store more than one thousand songs of karaoke data in high quality format which is enough for most users to practice karaoke. For example, a 2.5″ laptop external hard disk drive with 250 GB is used for data storage.

A portable HDD/SSD is convenient to use with the microphone set of the present invention. Using a computer, the AV data can be easily uploaded to the HDD/SSD. Because HDD/SSD is rewritable, the AV data can also be easily updated. The HDD/SSD is detachable connected with the microphone set of the present invention, so different HDD/SSD with different AV data stored and different capacities can be easily switched. This gives the user great flexibility. The format can be used in the present invention includes MP1, MP2, MP3, MP4, CD, CD G, etc.

Referring to FIG. 3, in a preferred embodiment of the present invention, the data module 22 is communicatively connected with the portable HDD/SSD though the data cable 71. Preferably, the data cable 71 is a USB cable 711. It is worth mentioning, a regular USB cable 711 has a length limitation for full speed transportation. But the USB cable 711 should not be too short for a user to practice karaoke. In the preferred embodiment, the USB cable 711 further comprises a USB connector 712 adapted to removably connected with the portable HDD/SSD, and a signal amplifier 713 electrically connected with the USB connector 712 to amplify the signals from the portable HDD/SSD. In the preferred embodiment, the signal amplifier 713 is a USB hub. More over, the power terminal 60 is electrically connected with the USB hub for connecting with the power lines V+ and V− of the USB cable 711.

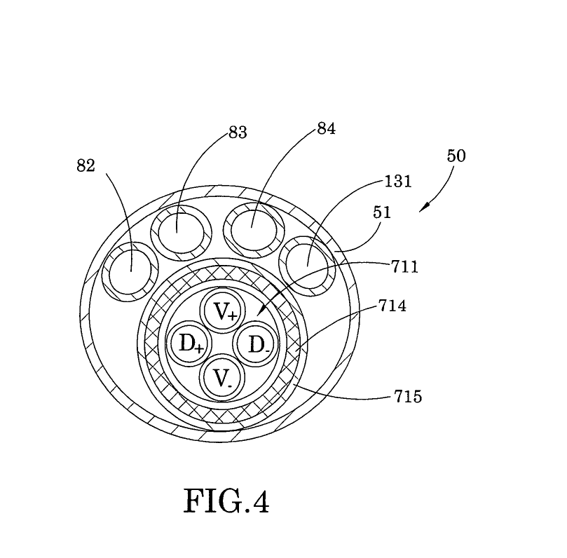

Referring to FIG. 4, in order to secure the quality of data transmitting, especially to shield the signal, the USB cable 711 is enclose by a shield layer 714. The shield layer 714 is formed by meshing metal wires into a longitudinal tube enclosing the USB cable 711 longitudinally. The diameter of the metal wire is ranged from 0.05 mm to 1.5 mm, and preferably is 0.1 mm; the number of the wires is ranged from 50 to 150, and preferably is 80. Then the shield layer 714 is further enclosed by an isolating layer 715.

The AV controller 20 further comprises a recording module 25 which is operatively linked to the audio/video module 23 for recording the sound signal being output to the AV system at real time. With this function, the user can record his voice mixed with the music accompaniment at the same time when he is singing using the present invention. It is important to know, when the user is using the microphone set of the present invention, the recording module is recording at real time, and the audio and video signal are output to the AV system by the audio/video module flawlessly, or in another ward, without stop and pause.

It is worth mentioning, it will take a lot of AV controller's resource to provide both karaoke functions and recording function simultaneously. In order to achieve this with low cost, the preferred embodiment of the present invention only records the sound signal, and the file information of the corresponding video data, such as the file name and path, instead of the large video data itself. This file information is saved together with the recorded sound signals. When the user play back the recorded song, the AV controller 20 will find out the video data using the saved file information, and play the corresponding video signal with the recorded sound signal in a synchronized manner. Because the data size of the sound signal and the file information is same, it can be saved in a SD card. The recording module 25 further comprises a card slot 251 to access a memory card 252 for saving and reading recorded sound signals as well as file information of the corresponding video data. Alternatively, other media can be used to replace the card 252. Preferably, the recording module 25 will record the sound signal being output to the AV system only and will save the sound signal at the memory card 252 in “Wav” or Mp3” format.

The preferred embodiment of the present invention provides karaoke functions including output adjusting and program selecting. The AV controller 20 comprises a sound equalizer 26 operatively linked to the audio/video module 23 for selectively adjusting parameters of the sound signal so as to enhance a quality of the sound signal being output to said AV system. Therefore, the user is able to select the echo, bass, treble, volume control, and different band equalizers of the sound equalizer 26 for precise audio and voice adjustments.

The AV controller 20 further comprises an operational selector 27 operatively linked to the data module 22 for selecting one of the AV data stored in the portable storage. The microphone housing 10 comprises a key board 11 which is electrically linked with the AV controller 20. The user can input commands through the key board 11 to control the performance of the microphone set.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A microphone set for an AV (audio/video) system including an external data storage and an AV display, comprising:
a hand-held microphone housing;
an AV controller, which is received in said microphone housing, comprising a voice module for receiving a voice signal from a user, a data module for receiving an external AV data from said external data storage which contains an audio data and a video data, an audio/video module adapted for operatively connecting to said AV display for transmitting a video signal and a sound signal thereto, and an audio generator operatively linked among said voice module, said data module, and said audio/video module, wherein said audio generator is arranged for splitting said AV data into said video data and said audio data to be converted into said video signal and an audio signal respectively, and for blending said voice signal with said audio signal to form said sound signal, so as to transmit said video signal and said sound signal to said AV display through said audio/video module;
a power terminal which is connected with said AV controller and is detachably connected with an external power source for power supplying;
a data terminal which is connected with said data module and is detachably connected with said external data storage for transmitting AV data; and
an AV terminal which is connected with said audio/video module and is detachably connected with said AV display for transmitting said video signal and said sound signal.

2. The microphone set, as recited in claim 1, wherein said data terminal further comprises a data cable extending from said microphone housing which is electrically connecting said data terminal with said data module.

3. The microphone set, as recited in claim 2, wherein said power terminal further comprises a power cable extending from said microphone housing, which is electrically connecting said power terminal with said AV controller.

4. The microphone set, as recited in claim 3, wherein said AV terminal further comprises an AV cable extending from said microphone housing which is electrically connecting said AV terminal with said audio/video module.

5. The microphone set, as recited in claim 1, further comprising an extension cable extended from said microphone housing and electrically connected to said AV controller for operatively connecting with an auxiliary microphone so as to process a secondary voice signal therefrom through said AV controller.

6. The microphone set, as recited in claim 4, further comprising an extension cable extended from said microphone housing and electrically connected to said AV controller for operatively connecting with an auxiliary microphone so as to process a secondary voice signal therefrom through said AV controller.

7. The microphone set, as recited in claim 6, wherein said data cable, said AV cable, said power cable, and said extension cable are united to form a single cable having one housing end extending from said microphone housing to operatively connect with said AV control, and a plurality of opposed connecting ends for detachably connecting to said portable storage, said AV system, said external power source, and said auxiliary microphone respectively.

8. The microphone set, as recited in claim 4, wherein said data cable is a USB cable, and said power terminal is electrically connected with two power wires of said USB cable.

9. The microphone set, as recited in claim 1, wherein said AV controller further comprises a recording module operatively linked to said audio/video module for recording said sound signal being output to said AV system at real time, wherein when said recording module is recording, said data module and said audio/video module are performing without interruption.

10. The microphone set, as recited in claim 4, wherein said AV controller further comprises a recording module operatively linked to said audio/video module for recording said sound signal being output to said AV system at real time, wherein when said recording module is recording, said data module and said audio/video module are performing without interruption.

11. The microphone set, as recited in claim 9, wherein said microphone housing contains a card slot provided thereat for removably receiving an external memory card to operatively link with said recording module so as to store said sound signal to be recorded by said recording module.

12. The microphone set, as recited in claim 10, wherein said microphone housing contains a card slot provided thereat for removably receiving an external memory card to operatively link with said recording module so as to store said sound signal to be recorded by said recording module.

13. The microphone set, as recited in claim 1, wherein said data terminal is 1 5 detachably connected to a portable storage where said AV data is stored for transmitting said AV data, and a data reader adapted for reading different digital formats of said AV data stored in said portable storage, wherein said portable storage is an external data storage selected from the group consisting of hard disk drive (HDD), solid state drive (SSD), and flash-based memory storage, to externally connect to said data module through said data cable.

14. The microphone set, as recited in claim 4, wherein said data terminal is detachably connected to a portable storage where said AV data is stored for transmitting said AV data, and a data reader adapted for reading different digital formats of said AV data stored in said portable storage, wherein said portable storage is an external data storage selected from the group consisting of hard disk drive (HDD), solid state drive (SSD), and flash-based memory storage, to externally connect to said data module through said data cable.

15. The microphone set, as recited in claim 7, wherein said data terminal is detachably connected to a portable storage where said AV data is stored for transmitting said AV data, and a data reader adapted for reading different digital formats of said AV data stored in said portable storage, wherein said portable storage is an external data storage selected from the group consisting of hard disk drive (HDD), solid state drive (SSD), and flash-based memory storage, to externally connect to said data module through said data cable.

16. The microphone set, as recited in claim 10, wherein said data terminal is detachably connected to a portable storage where said AV data is stored for transmitting said AV data, and a data reader adapted for reading different digital formats of said AV data stored in said portable storage, wherein said portable storage is an external data storage selected from the group consisting of hard disk drive (HDD), solid state drive (SSD), and flash-based memory storage, to externally connect to said data module through said data cable.

17. A method for receiving external AV data and outputting AV signal to an AV system, comprising steps of:
(a) inputting a voice signal through a microphone;
(b) receiving said external AV (audio video) data by a data module from an portable external data storage;
(c) generating a sound signal by mixing said voice signal with said audio data received from said portable external data storage;
(d) converting said video data received from said portable external data storage to video signal; and
(e) outputting said sound signal and said video signal to said AV system.

18. The method, as recited in claim 17, wherein said portable external data storage is a portable external data storage selected from a group consisting of hard disk drive (HDD), solid state drive (SSD), and flash-based memory storage.

19. The method, as recited in claim 18, wherein further comprises a step of:
(f) recording said sound signal and said video signal at real time.

20. The method, as recited in claim 17, wherein the step (b) further comprises a step of:
(b1) detachably connecting with said external data storage through a USB cable.

21. The method, as recited in claim 19, wherein the step (b) further comprises a step of:
(b1) detachably connecting with said external data storage through a USB cable.

22. The method, as recited in claim 17, wherein the step (e) further comprises a step of:
(e1) detachably connecting with said AV system through an AV cable.

23. The method, as recited in claim 21, wherein the step (e) further comprises a step of:
(e1) detachably connecting with said AV system through an AV cable.
